(19) United States
(12) Patent Application Publication
(10) Pub. No.: US 2026/0106662 A1
(43) Pub. Date: Apr. 16, 2026

(54) WIRELESS COMMUNICATION METHOD AND APPARATUS

(71) Applicant: QUECTEL WIRELESS SOLUTIONS CO., LTD., Shanghai (CN)

(72) Inventors: Ling LYU, Shanghai (CN); Zheng ZHAO, Shanghai (CN)

(21) Appl. No.: 19/410,317

(22) Filed: Dec. 5, 2025

Related U.S. Application Data
(63) Continuation of application No. PCT/CN2024/125049, filed on Oct. 15, 2024.

(51) Int. Cl. H04B 7/06

(52) U.S. Cl. CPC H04B 7/0696

(57) ABSTRACT

Provided are a wireless communication method and apparatus. One example method includes: receiving, in an observation window, a plurality of beams from a second device, wherein the plurality of beams are used to determine a first beam set; performing beam prediction on a second beam set in a prediction window based on measured values of the first beam set; and sending a first report to the second device, wherein the first report comprises information for one or K best beams in the second beam set, K is a positive integer, and the first beam set is determined based on first information; and the first information comprises at least two of: measured values of the plurality of beams, a capability of the apparatus, or a network configuration.

### CROSS-REFERENCE TO RELATED APPLICATIONS

This application is a continuation of International Application No. PCT/CN2024/125049, filed on Oct. 15, 2024, the disclosure of which is hereby incorporated by reference in its entirety.

### TECHNICAL FIELD

The present application relates to the field of communications technologies, and more specifically, to a wireless communication method and apparatus.

### BACKGROUND

In some beam management scenarios, a terminal device may predict a downlink transmit beam by using a model and report the predicted downlink transmit beam to a network device. For example, the terminal device may measure a beam in a received set B, to predict a best beam in a set A. However, how the terminal device determines the set B based on beams sent by the network device is not explicitly specified.

### SUMMARY

The present application provides a wireless communication method and apparatus. Various aspects of embodiments of the present application are described below. According to a first aspect, a wireless communication method is provided, including: receiving, by a first device in an observation window, a plurality of beams sent by a second device, where the plurality of beams are used to determine a first beam set; performing, by the first device, beam prediction on a second beam set in the prediction window based on a measured value of the first beam set; and sending, by the first device, a first report to the second device, where the first report is used to determine one or K best beams in the second beam set, K is a positive integer, and the first beam set is determined based on first information; and the first information includes at least two of: measured values of the plurality of beams, a capability of the first device, or a network configuration.

According to a second aspect, a wireless communication method is provided, including: sending, by a second device, a plurality of beams in an observation window, where the plurality of beams are used to determine a first beam set; and receiving, by the second device, a first report sent by a first device, where the first report is used to determine one or K best beams in a second beam set in a prediction window, K is a positive integer, beam prediction of the second beam set is performed based on a measured value of the first beam set, and the first beam set is determined based on first information. The first information includes at least two of: measured values of the plurality of beams, a capability of the first device, or a network configuration.

According to a third aspect, a wireless communication apparatus is provided, where the apparatus is a first device and includes: a transceiver unit, receiving, in an observation window, a plurality of beams sent by a second device, where the plurality of beams are used to determine a first beam set; and a processing unit, performing beam prediction on a second beam set in the prediction window based on a measured value of the first beam set, where the transceiver unit is further configured to send a first report to the second device; and the first report is used to determine one or K best beams in the second beam set, K is a positive integer, and the first beam set is determined based on first information. The first information includes at least two of: measured values of the plurality of beams, a capability of the first device, or a network configuration.

According to a fourth aspect, a wireless communication apparatus is provided, where the apparatus is a first device and includes: a transceiver unit, sending a plurality of beams in an observation window, where the plurality of beams are used to determine a first beam set. The transceiver unit is further configured to receive a first report sent by the first device. The first report is used to determine one or K best beams in a second beam set in a prediction window, K is a positive integer, beam prediction of the second beam set is performed based on a measured value of the first beam set, and the first beam set is determined based on first information. The first information includes at least two of: measured values of the plurality of beams, a capability of the first device, or a network configuration.

According to a fifth aspect, a communication apparatus is provided, including a memory and a processor. The memory is configured to store a program, and the processor is configured to invoke the program in the memory to execute the method according to the first aspect or the second aspect.

According to a sixth aspect, an apparatus is provided, including a processor, invoking a program from a memory to execute the method according to the first aspect or the second aspect.

According to a seventh aspect, a chip is provided, including a processor, invoking a program from a memory, to cause a device on which the chip is installed to execute the method according to the first aspect or the second aspect.

According to an eighth aspect, a computer-readable storage medium is provided, where the computer-readable storage medium stores a program, and the program causes a computer to execute the method according to the first aspect or the second aspect.

According to a ninth aspect, a computer program product is provided, including a program, where the program causes a computer to execute the method according to the first aspect or the second aspect.

According to a tenth aspect, a computer program is provided, where the computer program causes a computer to execute the method according to the first aspect or the second aspect.

After receiving a plurality of beams in an observation window, a first device in embodiments of the present application may determine a first beam set based on at least two of: measured values of the plurality of beams, a capability of the first device, or a network configuration. The first beam set may be used by the first device to perform beam prediction on a second beam set. It may be learned that when a second device sends the plurality of beams, the first device does not need to determine uses of these beams, but directly determines and measures the first beam set, so that model inference efficiency can be improved.

### BRIEF DESCRIPTION OF THE DRAWINGS

FIG. 1 shows a wireless communication system to which embodiments of the present application are applied.

FIG. 2 is a schematic diagram of a model processing process to which embodiments of the present application are applied.

FIG. 3 is a schematic flowchart of model inference on a terminal device side to which embodiments of the present application are applied.

FIG. 4 is a schematic flowchart of a wireless communication method according to an embodiment of the present application.

FIG. 5 is a schematic flowchart of a possible implementation of the method shown in FIG. 4.

FIG. 6 is a schematic flowchart of another possible implementation of the method shown in FIG. 4.

FIG. 7 is a schematic diagram of a possible implementation of the method shown in FIG. 4.

FIG. 8 is a schematic diagram of a structure of a wireless communication apparatus according to an embodiment of the present application.

FIG. 9 is a schematic diagram of a structure of another wireless communication apparatus according to an embodiment of the present application.

FIG. 10 is a schematic diagram of a structure of a wireless communication apparatus according to an embodiment of the present application.

### DETAILED DESCRIPTION OF THE EMBODIMENTS

The following describes the technical solutions in embodiments of the present application with reference to the accompanying drawings.

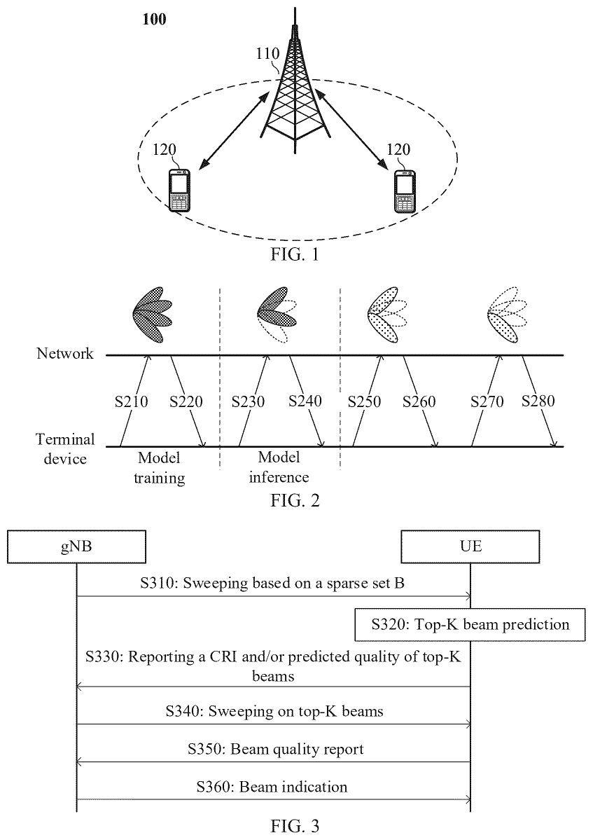

FIG. 1 is a schematic diagram of an architecture of a wireless communication system 100 to which embodiments of the present application are applied. As shown in FIG. 1, the wireless communication system 100 may include a network device 110 and a terminal device 120. The network device 110 may be a device that communicates with the terminal device 120. The network device 110 may provide communication coverage in a specific geographic area, and may communicate with a terminal device located in the coverage area.

FIG. 1 exemplarily shows one network device and two terminal devices. Optionally, the wireless communication system 100 may include a plurality of network devices, and another quantity of terminal devices may be included in coverage of each network device, which is not limited. That is, the wireless communication system may include one or more network devices, and each network device may support wireless communication of one or more terminal devices.

In embodiments of the present application, the wireless communication system shown in FIG. 1 may further include other network entities such as a mobility management entity (mobility management entity, MME), or an access and mobility management function (access and mobility management function, AMF), and a network controller, which is not limited in embodiments of the present application.

It should be understood that embodiments of the present application may be applied to various communication systems. For example, embodiments of the present application may be applied to a global system for mobile communications (global system of mobile communication, GSM), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an advanced long term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunications system (universal mobile telecommunication system, UMTS), a wireless local area network (wireless local area networks, WLAN) system, a wireless fidelity (wireless fidelity, WiFi) system, and a 5th-generation (5th-generation, 5G) communication system. Embodiments of the present application may be further applied to another communication system, for example, a future communication system such as a 6th-generation (6th-generation, 6G) mobile communication system or a satellite (satellite) communication system.

Conventional communication systems support a limited quantity of connections and are easy to implement. However, with development of communication technologies, a communication system may support not only conventional cellular communication but also one or more other types of communication. For example, the communication system may support one or more types of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, vehicle-to-everything (vehicle to everything, V2X) communication, and the like. Embodiments of the present application may also be applied to a communication system that supports the foregoing communication manners.

The communication system in embodiments of the present application may be applied to a carrier aggregation (carrier aggregation, CA) scenario, a dual connectivity (dual connectivity, DC) scenario, or a standalone (standalone, SA) networking scenario.

The communication system in embodiments of the present application may be applied to an unlicensed spectrum. The unlicensed spectrum may also be considered as a shared spectrum. Alternatively, the communication system in embodiments of the present application may be applied to a licensed spectrum. The licensed spectrum may also be considered as a dedicated spectrum.

Embodiments of the present application may be applied to a non-terrestrial network (non-terrestrial network, NTN) system. In an example, the NTN system may be a 4G-based NTN system, an NR-based NTN system, an NTN system based on an internet of things (internet of things, IoT), or an NTN system based on a narrow band internet of things (narrow band internet of things, NB-IoT).

The wireless communication system in the present application embodiment may use the following resources to support wireless communication with one or more communication devices: time resources (for example, symbols, subslots, slots, subframes, and frames) or frequency resources (for example, subcarriers and carriers). Additionally, the wireless communication system may support wireless communication across various radio access technologies (radio access technology, RAT). The various radio access technologies include 3rd generation (3G) radio access technologies, 4th generation (4G) radio access technologies, 5th generation (5G) radio access technologies, and other suitable radio access technologies beyond 5G.

The terminal device in embodiments of the present application may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a user communication device, a wireless communication device, a user agent, or a user apparatus.

In some embodiments, the terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device, or another processing device connected to a wireless modem, a vehicle-mounted device, a wearable device, a terminal device in a next-generation communication system (such as an NR system), a terminal device in a future evolved public land mobile network (public land mobile network, PLMN), or the like.

The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover various names in the following, or may be interchanged with the following names, for example, a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a wireless node, an access point (access point, AP), a transmission node, a transceiver node, a base band unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, a network communication device, or the like. The base station may be a macro base station, a micro base station, a relay node, a donor node, or the like, or a combination thereof. Alternatively, the base station may be a communication module, a modem, or a chip disposed in the device or the apparatus described above. Alternatively, the base station may be a mobile switching center, a device that functions as a base station in D2D, V2X, or M2M communication, a network-side device in a 6G network, a device that functions as a base station in a future communication system, or the like. The base station may support networks with a same access technology or different access technologies. A specific technology and a specific device used by the network device are not limited in embodiments of the present application.

The base station may be a fixed or mobile base station. For example, a helicopter or an uncrewed aerial vehicle may be configured to function as a mobile base station, and one or more cells may move according to a location of the mobile base station. In another example, a helicopter or an uncrewed aerial vehicle may be configured to function as a device communicating with another base station.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or some of functions of the communication device in the present application may also be implemented by software functions running on hardware, or by virtualization functions instantiated on a platform (for example, a cloud platform).

In embodiments of the present application, the network device may provide a service for a cell. The terminal device communicates with the network device by using a transmission resource (for example, a frequency resource or a spectrum resource) used by the cell. The cell may be a cell corresponding to the network device (for example, a base station). The cell may belong to a macro station or may belong to a base station corresponding to a small cell (small cell). The small cell herein may include a metro cell (metro cell), a micro cell (micro cell), a pico cell (pico cell), a femto cell (femto cell), or the like. These small cells have characteristics of small coverage and low transmit power, and are suitable for providing a high-rate data transmission service.

It should be understood that a device having a communication function in a network/system in embodiments of the present application may be referred to as a communication device. The wireless communication system 100 shown in FIG. 1 is used as an example. The communication device may include a network device 110 and a terminal device 120 that have a communication function, and may further include another device in the wireless communication system 100, for example, another network entity such as a network controller or a mobility management entity, which is not limited in embodiments of the present application.

For ease of understanding, some relevant technical knowledge related to embodiments of the present application is first described. The following related technologies, as optional solutions, may be randomly combined with the technical solutions of embodiments of the present application, all of which fall within the protection scope of embodiments of the present application. Embodiments of the present application include at least a part of the following content.

In a wireless communication system, a terminal device may obtain a beam (which may also be referred to as a spatial beam), to implement a wireless connection from the terminal device to a wireless network. For example, the terminal device may perform beam sweeping on an available beam sent by the wireless network, and measure attributes of the beam. The attributes of the beam are, for example, signal strength and signal quality. For example, after performing beam sweeping, the terminal device may further perform beam refinement, to achieve a group of potentially narrower beams used for wireless connection to the wireless network. The beam may not only implement wireless connection between the terminal device and the wireless network, but also implement high directional precision and high signal quality for wireless signal transmission between the terminal device and the wireless network.

With development of communication technologies, research on artificial intelligence (artificial intelligence, AI)/machine learning (machine learning, ML) technologies based on air interfaces of communication systems (for example, NR systems) becomes one of directions. An objective of the research includes exploring how to enhance an advantage of the air interface. For example, related performance of the air interface can be enhanced by enhancing support for AI/ML algorithms. For another example, complexity and/or overheads of the air interface can be reduced by enhancing support for AI/ML algorithms.

Research on AI/ML technologies can also enhance capabilities related to beam management (beam management, BM). In an example, AI/ML enhancements related to beam management may support reduced overheads and reduced beam measurement and reporting delays. In an example, an AI/ML model may be applied to predict a beam, so as to improve transmission efficiency of the air interface.

A whole process of applying an AI/ML model for enhancement includes: model training, model inference, and model monitoring. In this process, the AI/ML model, after being trained, can generate a set of outputs based on a set of inputs. The input may be a set of beam measured values, and the output may be a set of beams different from or larger than the input.

In a model inference process, the AI/ML model can predict a best beam in a set of different or larger set of beams by using a set of beam measured values.

In some embodiments, the AI/ML model may be located on a terminal device side or the terminal device performs model training and/or model inference. The model may be referred to as a UE-side model (UE-side model). For example, the AI model may be located at the terminal device or the terminal device trains the AI model and/or generates a best beam by using inference of the AI model.

In an example, the terminal device may use a beam in a set B (Set B, also referred to as beam group B) as an input of the ML model. The ML model may predict a best beam in a set A (Set A, also referred to as beam group A), and the beam is not completely measured by the terminal device.

In the example described above, the set B may be a beam group first measured by the terminal device. The set B may be a plurality of beams sent by a base station (for example, a gNB). Each beam may correspond to a different direction or angle, so as to cover a plurality of spatial directions. Each beam may further correspond to a measurement signal, which is used to obtain a measured value, such as a reference signal received power (reference signal received power, RSRP). The set B is used to provide the model with preliminary environmental information and channel conditions. In the example described above, the set A may be a beam group that needs to be predicted. The set A usually has a larger quantity of beams than set B, or may have more concentrated beam directions. The AI/ML model may predict a best beam in the set A by measuring the set B, to improve data transmission efficiency.

Optionally, beams in the set A and the set B may be in a same frequency range. Selection of the set B may be given by the base station or determined by the terminal device itself. A relationship between the set A and the set B may be that: the set A is different from the set B (the set B is not a subset of the set A), the set B is a subset of the set A (the set A is different from the set B), or the set A and the set B are the same. For the first two cases, the set B may be transmitted in both a measurement window and a prediction window, or may be transmitted only in a measurement window. For the last case, reference signal (reference signal, RS) transmission overheads may be reduced, and the set B used as measurement resources may be transmitted only in the measurement window.

Optionally, 64 or more beams may be used as a size of the beam set A. For future-oriented networks, a network device will be able to transmit 64 more highly directional narrow beams. More narrow beams may also be used to sweep a larger set A. For example, the quantity of beams in the set A may be as large as 256.

Optionally, the network device may send a channel state information reference signal (channel state information-reference signal, CSI-RS) or a synchronization signal block (synchronization signal block, SSB) as a reference signal. It should be understood that the SSB may also represent a synchronization signal/physical broadcast channel block (synchronization signal/physical broadcast channel block, SS/PBCH block). The SSB includes a primary synchronization signal (primary synchronization signal, PSS) and a secondary synchronization signal (secondary synchronization signal, PSS).

Optionally, the terminal device estimates channel quality of each beam by measuring an RSRP of the received CSI-RS/SSS.

Optionally, in a model training process, the AI/ML model may adjust its weights by minimizing a loss function, so that the model can accurately predict a best beam in the set A from an RSRP measurement result of the set B.

In some embodiments, the AI/ML may be located on a network device (such as a base station) side, or the network device performs model training and/or model inference. The model may be referred to as a network-side model (NW-side model). For example, the AI model may be located at the base station or the base station trains the AI model and/or generates a best beam by using inference of the AI model.

In some embodiments, a network may completely control a data collection process of model training on the terminal device side, including starting, termination, and management of data collection and data transmission.

During a model monitoring process, AI/ML model monitoring is used for at least the following purposes: model activation, deactivation, selection, switching, rollback, or updating (including retraining). The model monitoring may also be referred to as a process of monitoring AI/ML model inference performance. There is definitely a time interval between model training and inference. When radio parameters/conditions change in the network, there is a high probability of errors occurring in an inference phase of a model, and therefore the model needs to be continuously modified and trained based on a result of the model monitoring.

In comparison with other beam management technologies, based on beam prediction, the terminal device can experience a reduced delay, reduced overheads, reduced power consumption, and improved signal quality by using beam management that supports the AI/ML technology.

For ease of understanding, the following describes an entire process of model processing on the terminal device side with reference to FIG. 2. FIG. 2 is shown from a perspective of interaction between a terminal device side (for example, UE) and a network (network, NW) side. Four beams on the network side are used as an example. It can be learned from FIG. 2 that the entire process may include a model training (model training) process, a model inference (model inference) process, and a reporting process. The model training process includes step S210 and step S220, and the model inference process includes step S230 and step S240.

Refer to FIG. 2. Step S210: Reporting, by the terminal device, training-related information (UE report training-related information).

Step S220: Performing, by the network side, beam sweeping (beam scanning) based on the four beams.

Step S230: Reporting, by the terminal device, inference-related information (UE report inference-related information).

Step S240: Selecting, by the network side, two beams from the four beams based on the reporting from the terminal device to perform beam sweeping.

Step S250: Reporting, by the terminal device, K best beams (top-K beam report).

Step S260: Reporting, by the network side, beam sweeping based on beams in the beam report. It can be learned from FIG. 2 that the two beams on which the network side performs beam sweeping in step S260 may be different from the two beams on which the network side performs beam sweeping in step S240.

Step S270: Sending, by the terminal device, a beam report (beam report), so that the network side determines a best beam.

Step S280: Sending, by the network side, a beam indication (beam indication) to the terminal device.

The foregoing describes, with reference to FIG. 2, a process of processing a model when the model is located on the terminal device side. To complete the entire process, the terminal device needs to collect and analyze data. As previously described, a data collection process may include starting, transmission, and management of data collection and data transmission. The following describes data collection and analysis by using a terminal device-side model as an example.

For the terminal device-side model, a behavior of the terminal device or content that the terminal device reports may vary depending on whether it is a measurement resource for training, inference, or monitoring. That is, the content may be different for different terminal device behaviors or terminal device reports. Therefore, during configuration of measurement related to an AI/ML operation for the terminal device-side model, a purpose of the measurement configuration or an implied terminal device behavior (for example, training, inference, monitoring, or a non-AI/ML operation) needs to be indicated to the terminal device.

In an example, for the training process, the terminal device may only need to measure a beam for which a resource is configured. For example, model inputs and labels generated based on a set A/set B may be used for internal training on the terminal device side, and may not need to be reported to the network device.

In an example, for the inference process, the terminal device may need to measure a transmit (transmit, Tx) beam from the set B and use it as a model input, and in addition, the terminal device should report a model output about a predicted beam/RSRP value.

For data collection, in this embodiment of the present application, data collection may be started/triggered by a configuration of a network, or data collection may be performed upon a request of the terminal device. Data collection for different purposes may correspond to different behaviors of the terminal device.

In an example, collected data may be used to train an AI model or allow the terminal device to have a preliminary understanding of network performance. When performing data collection based on a training data set, the terminal device needs to be equipped with a mechanism to determine when and what data to collect for effective training. Because the network side may not know a specific data requirement of the terminal device or an optimal time for data collection, the terminal device may autonomously trigger the collection process and report a related configuration. For example, for an AI/ML model on the terminal device side, an input of the AI/ML model may include layer 1 (layer 1, L1) RSRPs of 8 SSBs, and an output may include predicted L1-RSRPs of 32 CSI-RSs. The 8 SSBs may correspond to the set B used for training purposes, and the 32 CSI RSs may correspond to the set A used for training purposes.

The AI/ML model in the foregoing example is used as an example. In order that the terminal device collects data used for training the AI/ML model, the network may configure a first SSB resource set and a first CSI-RS resource set for the terminal device. In the first SSB resource set, an SSB resource indicator (resource indicator, RI) or resource index (resource index, RI) may range from 1 to 8. The SSB RI may be defined based on an identifier (identity, ID) associated with each SSB in an SSB resource set. In the first CSI-RS resource set, a CSI-RS resource indicator or index (CSI-RS RI, CRI) may range from 1 to 32. The CRI may be defined based on an ID associated with each CSI-RS in a CSI-RS resource set.

Optionally, a CSI-RS in the first CSI-RS resource set shares a same periodicity as an SSB in the first SSB resource set.

Optionally, the terminal device may collect L1-RSRPs about an SSB and a CSI-RS in various time scenarios, and upload data to an over the top (over the top, OTT) server for offline model training.

Optionally, in the model training process, an L1-RSRP corresponding to an SSB RI=m (1≤m≤8) in the first SSB resource set may be used to determine an input value of an m^{th} input feature of the AI/ML model, and an L1-RSRP corresponding to a CRI=n (1≤n≤32) in the first CSI-RS resource set may be used to determine a value label related to an n^{th} output feature of the AI/ML model. Then this offline-trained AI/ML model may be downloaded back to the terminal device for future model inference.

The terminal device-side model is still used as an example below to describe a model inference and reporting process. The process also includes a beam management inference process.

For an inference process of the terminal device-side model, the terminal device measures RSs of beams in the set B, predicts top-K beams in the set A, and reports a prediction result to the network. In a conventional L1-RSRP report, the terminal device should report an L1-RSRP value of a channel measurement resource (channel measurement resource, CMR) associated with a CSI report. However, for artificial intelligence-based beam management, a beam group (set B) used for measurement and a beam group (set A) used for reporting may be different. Therefore, to instruct the terminal device to report a prediction result, an association between the set A and the set B should be indicated to the terminal device.

It should be noted that the association between the set A and the set B also needs to be confirmed in the model training process. For model training, a measurement result of the set B is used as a model input and a measurement result of the set A is used as a truth label. Therefore, a method for associating the set B with the set A may be: configuring both a resource of the set A and a resource of the set B for the terminal device in advance. However, for model inference, the terminal device only needs to measure beams in the set B, and resources or indexes of beams in the set A are used only for reporting. Therefore, a key issue in the model inference process is how to represent resources or indexes of the set A.

In the inference process, the terminal device does not measure the beams in the set A. Therefore, RSs of the beams in the set A do not need to be configured. However, in some scenarios, the RSs of the beams in the set A may be configured for the terminal device for other purposes, for example, for performance monitoring. In this case, both a resource set of the set B and a resource set of the set A are configured for the terminal device. It may be learned that the network may configure the resource set of the set B and the resource set of the set A based on different purposes. A CSI resource is used as an example. The terminal device needs to know a purpose of the configured CSI resource (for training, inference, monitoring, or a non-AI/ML operation), because a corresponding CSI report type may vary.

In an example, for a monitoring process, based on a result of discussion of a monitoring type, the terminal device may need to measure a monitoring resource configured by the network device and report a model output/label, or report a calculated metric (for example, beam prediction accuracy). For a conventional non-AI/ML operation, the terminal device may need to measure Tx beams and report the measured beams/RSRPs.

In an inference process of the AI/ML model, measured values based on the beams in the set B may be used as an input of the model input. In addition, beam ID information may be further provided as a model input. Based on the model output, top-1/top-K beams in the set A may be obtained (obtain Top-1/K beams among Set A of beams), or predicted L1-RSRPs may be used to determine top-1/top-K beams (depending on labels) in the set A.

Optionally, the model output is, for example, a probability of each beam in the set A becoming the top-1 beam (probability of each beam in Set A to be the Top-1 beam), or predicted L1-RSRPs (predicted LI-RSRPs).

In some scenarios, the terminal device may support beam prediction in spatial domain and/or time domain, that is, BM-Case1 and/or BM-Case2. Based on AI/ML enhancements, the beam prediction in spatial domain (BM-Case1) and the beam prediction in time domain (BM-Case2) can reduce overheads of the terminal device and decrease delays in beam measurement and reporting. BM-Case1 is spatial domain downlink (downlink, DL) beam prediction for the set A based on a measurement result of the set B. For BM-case 1, measured values of set B (measurements based on Set B of beams) are used as a model input to predict the top-1/top-K beams in the set A. BM-Case2 is time domain DL beam prediction for the set A based on a historical measurement result of the set B. For BM-Case2, measured values of the beams in the set B at one or more historical time instances (measurements based on Set B of beams at historic time instance(s)) may be used as a model input, to predict time domain DL beams of the beams in the set A. Prediction of DL Tx beams and prediction of DL Tx/Rx beams may also be used to evaluate prediction performance.

For BM-Case1 and BM-Case2, the terminal device may report a prediction result to the NW based on outputs of the terminal device-side model, or the NW may predict top-1/top-K beams based on a measurement report of the set B of the NW-side model.

The terminal device-side model is still used as an example. For BM-Case1 having a terminal device-side AI/ML model, a conventional transmission configuration indicator (transmission configuration indicator, TCI) state mechanism may be used for beam indication of a beam. Optionally, the terminal device may report a measurement result of four or more beams in one reporting instance. For BM-Case2 having a terminal device-side AI/ML model, the terminal device may report the following information of AI/ML model inference to the NW in a report example: beams used in N future time instances that are output by the AI/ML model inference; timestamp information corresponding to a reported beam; and information about measured values in a plurality of past time instances.

In a beam management inference process, the beam indication is also important information. After the terminal device reports the top-K predicted beams, the NW further indicates beams used for second-step measurement, or the terminal device may directly trigger the second-step measurement. Different from BM-case1, in BM-Case2, top-K beams corresponding to a plurality of time instances may be obtained. Time information needs to be considered for beam indication on the network device side.

In an example, the network device may indicate beams to the terminal device by using a plurality of indications. An advantage of this is that the network device may select a more appropriate beam based on a real-time channel change.

With reference to FIG. 3, the following describes a beam prediction-based model inference process based on interaction between UE and a gNB by using a UE-side model as an example.

Refer to FIG. 3. Step S310: Performing, by the gNB, sweeping based on a sparse set B (sparse Set B sweeping).

Step S320: Predicting, by the UE-side model, top-K beams (Top-K beam prediction). UE inputs measured values of beams in the set B into an AI model, and outputs indexes, L1-RSRPs, and beam IDs or beam indexes of the K best beams in all measured beams. The UE-side model may further output an L1-RSRP of a best beam and differences between RSRPs of other K-1 beams and the L1-RSRP of the best beam, and report the differences to a base station. A value of K may be configured by the base station, or the UE may determine the value of K based on a moving speed, location information, and a service mode.

Step S330: Reporting a CRI and/or predicted quality of top-K beams (report CRI and/or predicted quality of Top K beam).

Step S340: Continuing, by the gNB, to initiate sweeping by using best top-K beams (Top-K beam sweeping). A top-K beam sweeping program may be configured by the gNB. Step S340 is an optional step.

Step S350: Reporting, by the UE, beam quality (beam quality report). The UE may report an actual top 1 best beam, or may report indexes and L1-RSRPs of some or all of the K best beams. The UE may reuse a conventional beam reporting mechanism.

Step S360: Indicating, by the gNB, a beam for DL data transmission. The gNB may reuse a conventional TCI beam indication mechanism.

The foregoing describes a procedure of beam management or beam prediction based on an AI/ML model with reference to FIG. 2 and FIG. 3. AI/ML-based beam management enhancements still face some problems that need to be solved or studied.

In an example, when a terminal device uses an AI algorithm to process beams detected and measured from a wireless network so as to infer other beams that may have higher strength and/or higher quality, the terminal device needs to ensure model consistency between a training phase and an inference phase. As previously described, there is a time interval between the training phase and the inference phase, and changes in radio parameters/conditions may cause errors in the inference phase.

In an example, it may be learned from the foregoing description that the set A usually has a larger quantity of beams than the set B. The set B usually represents a measurement set or a partial set of downlink reference signals, and is used to assist a network side in beam prediction and selection. However, the terminal device may not need to know whether beam sweeping performed by the network device is used for beams in the set A or beams in the set B, or even a non-AI/ML-based BM. Therefore, how the terminal device determines beams in the set B from beams sent by the network device is a problem that needs to be considered.

It should be understood that the foregoing describes an existing problem by using a terminal device-side model as an example, and embodiments of the present application may be further applied to a network-side model.

Based on this, an embodiment of the present application provides a wireless communication method. In this method, after receiving a plurality of beams sent by a second device, a first device may determine a first beam set (set B) based on at least two of: measured values of the beams, a capability of the first device, or a network configuration, to perform beam prediction on a second beam set (set A). According to this method, the first device may determine the first beam set by itself based on an actual situation, thereby improving flexibility of beam prediction.

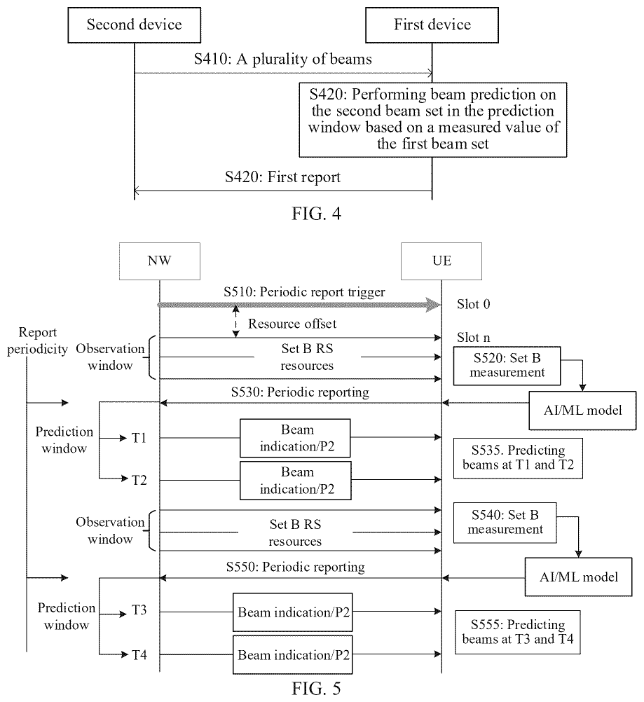

The wireless communication method proposed in this embodiment of the present application is described in detail below with reference to FIG. 4. FIG. 4 is described from a perspective of interaction between a first device and a second device.

The first device may be any type of terminal device described above, or may include any type of terminal device. For example, the first device is UE. For another example, the first device may include a terminal device and any processing device used for beam prediction.

In some embodiments, the first device supports enhancements based on AI/ML operations. For example, the first device has a function of enhancing beam management based on an AI/ML operation.

In some embodiments, a first model is deployed on the first device, to implement beam prediction. When the second device is a network device, the first device performs DL beam prediction. When the second device is a terminal device, the first device performs sidelink beam prediction.

In an example, the first model is a model that supports an AI algorithm or ML, that is, the first model is an AI/ML model.

In an example, beam prediction implemented by the first model may be the foregoing BM-Case1, may be BM-Case2, or may be another future beam prediction type, which is not limited herein.

In some embodiments, the first model is deployed on a first device side. That is, the first model is not located on the terminal device, but on a server communicating with the terminal device. For example, the first model is located on an OTT server directly communicating with the terminal device.

The second device may be any network device communicating with the first device, or may be a terminal device communicating with the first device. When the first device is within coverage of the network device, the second device may be the network device. In a sidelink communication system, the first device communicates with a terminal device, and the second device may be the terminal device.

In some embodiments, the second device can monitor a process in which the first device processes the first model. For example, the second device may determine, based on a report sent by the first device, whether a current stage is a training stage or an inference stage of the first model.

In some embodiments, the second device supports AI/ML operations. The first model may be deployed on a second device side.

In some embodiments, the second device may send a plurality of beams to the first device a plurality of times to facilitate measurement performed by the first device, and perform model training and model inference on the first model based on a measurement result.

Refer to FIG. 4. Step S410: Receiving, by the first device, a plurality of beams sent by the second device. A window in which the first device receives the plurality of beams or a window in which the second device sends the plurality of beams is an observation window. That is, the first device receives, in the observation window, the plurality of beams sent by the second device.

The observation window is used by the first device to receive the plurality of beams. The observation window includes RS resources of the plurality of beams, and the resources need to be configured.

In some embodiments, an observation window of the first device may be periodically configured. For example, when the second device periodically sends a plurality of beams, the first device may set one or more observation windows based on a transmission period of the plurality of beams. When the second device periodically transmits a plurality of beams, the periodically transmitted plurality of beams may be shared by a plurality of terminal devices including the first device. That is, the plurality of beams sent periodically may correspond to a plurality of observation windows, and observation windows of a plurality of terminal devices may correspond to the plurality of observation windows respectively, which is subsequently described with reference to FIG. 5.

In an example, each terminal device has a corresponding observation window, and therefore an observation window in which the first device receives a plurality of beams is different from an observation window in which another terminal device receives beams. Optionally, an observation window in which the first device receives a plurality of beams partially overlaps an observation window in which another terminal device receives beams.

In an example, when the second device sends a plurality of beams based on a periodicity, the plurality of beams are sent even in a prediction window in which the first device performs model inference. For example, when model inference is performed based on periodic beam group B, the NW still transmits the periodic beam group B even in a prediction window. In this scenario, the observation window may overlap the prediction window. In an overlapping time resource, the first device may choose to receive a beam sent by the second device, or may not receive a beam sent by the second device.

In some embodiments, periodic beam sending may be triggered based on triggering of periodic prediction reporting. The network may configure, for the first device, an RS resource of the first beam set used for inference of the first model. The first device may identify, based on a resource periodicity and an offset for configuring the RS resource of the first beam set, a slot of an RS corresponding to each scheduled first beam set, so as to perform beam measurement at one or more corresponding time points. The RS resource may also be referred to as an RS resource of a plurality of beams sent by the second device.

In an example, the RS resource of the first beam set may be located in the observation window of the first device. Beam resources corresponding to a plurality of time instances may be configured in the observation window. Considering that the first beam set may vary in each time instance, a resource of the first beam set in each time instance in the observation window may be configured as an RS set.

In periodic reporting or periodic beam sending, the observation window is one of a plurality of observation windows. The observation window of the first device may be one or more of a plurality of observation windows. Locations of the plurality of observation windows may be determined based on a location of an initial observation window and a first period. The first beam set is used for repeated transmission in a plurality of observation windows.

In an example, the first period may be equal to a report periodicity, or may not be equal to the report periodicity.

In an example, the first device may be one of a plurality of devices that share a periodic RS resource. The plurality of devices may perform beam prediction based on a first beam set in any one of the plurality of observation windows.

In some embodiments, the network may configure a length of the observation window for the first device. For example, a time period of a quantity of slots required is used as RS resources. The observation window may be an RS set configured by the network for the first device, so that the first device performs measurement for CSI reporting or other reporting. These resource configurations are periodic resources, and different time instances may correspond to different RS configurations.

In some embodiments, a length of the observation window may be configured or adjusted based on one or more of the following manners: performing configuration by using a third parameter, where the third parameter is used to define the length of the observation window; determining the length of the observation window by using a report offset and a resource offset; increasing the length of the observation window by increasing a report periodicity or decreasing a reference signal resource offset; reducing the length of the observation window by reducing a report periodicity or increasing a reference signal resource offset; or predicting the length of the observation window based on the quantity of time instances corresponding to the first beam set.

In an example, the window length (duration) of the observation window may be indicated by using a CSI framework or is configurable.

In an example, when the length of the observation window may be configured based on the third parameter, the third parameter may directly define the length of the observation window. For example, the length of the observation window may be a new information element (information element, IE) IE defined in csi-ReportConfig. The new IE may directly define a window length, for example, is set to 20 slots or 50 slots. In this configuration manner, the network operator can more directly control the duration of the observation window without relying on a difference between a report offset and a resource offset.

In an example, the length of the observation window may be determined based on a periodically reported report offset and a resource offset amount. For example, a value of a parameter ReportPeriodityAndOffset configured by the network may determine the report offset amount, and a value of a parameter ResourcePeriodityandOffset may determine the resource offset amount. ResourcePeriodityandOffset is used to indicate a period and an offset of an RS resource in the first beam set, and defines a slot from which the terminal device starts to measure the RS resource, and a quantity of slots at which the RS resource is repeated.

For example, the first device may determine the length of the observation window by using values of ReportPeriodityAndOffset and ResourcePeriodityandOffset. A definition of the length of the observation window may be described as: L_{w}=T [symbol] −T_{RS}, where L_{w} is the length of the observation window, T [symbol] is a slot of a 1^{st} report, T_{RS} is a 1^{st} RS resource slot of the first beam set, and is also a start slot of the observation window.

Optionally, T_{RS} may be described as: T_{RS}=slot0+offset1, where slot 0 is a location of slot 0; and offset1 is an RS resource offset (ResourceOffset) of the first beam set, and indicates a slot from which the RS resource of the first beam set starts.

Optionally, the slot T [symbol] of the 1^{st} report may be described as: T [symbol] =slot0+offset2, where offset 2 is a report offset (ReportOffset), and indicates a slot from which the report starts.

Therefore, the length of the observation window may be described as: L_{w}=T [symbol] −T_{RS}=offset 2−offset 1.

It may be learned from the foregoing description that the length of the observation window usually depends on a difference between the report offset and the RS resource offset amount, and the difference determines an amount of measurement information that can be accumulated by the first device before each time of reporting. In an example, in order to configure or adjust the length of the observation window, the following elements may be added to the CSI framework: report periodicity (report periodicity), report offset (report offset), RS resource periodicity (resource periodicity), and RS resource offset (resource offset).

Optionally, the report periodicity may be used to configure how long (in slots) the terminal device reports CSI once.

Optionally, the report offset may be used to configure an offset of a report slot relative to a time axis, so as to determine a start slot of the report.

Optionally, the RS resource periodicity may be used to configure a repetition period of RS resources in the first beam set, to determine a quantity of slots after which the first device can measure a same resource.

Optionally, the RS resource offset may be used to configure a start slot of the RS resource, to determine a start point of the measurement window or the observation window.

In an example, the network side may prolong the duration of the observation window by increasing the report periodicity or decreasing the RS resource offset. This allows the first device to collect more RS resources over a longer period of time. The RS resource offset can be reduced so that RS resource measurement starts in an earlier slot. This method is applicable to scenarios in which more accurate channel state information is required, for example, in environments with high interference or high signal-to-noise ratios.

Optionally, configuration manners of prolonging the length of the observation window may further include: increasing a report offset so that the slot of the 1st report is later, and a longer period of time is provided for measuring the RS resource.

In an example, the network side may shorten the length of the observation window by reducing the report periodicity or increasing the RS resource offset. In some scenarios with light load or with a stable environment, the network may shorten the length of the observation window to reduce computing load or resource overheads of the first device.

For example, the length of the observation window may be predicted based on the quantity of time instances corresponding to the first beam set. The quantity of time instances may be configured by the network, or may be dynamically adjusted. As in BM-Case2, the observation window may include three time instances of beam transmission.

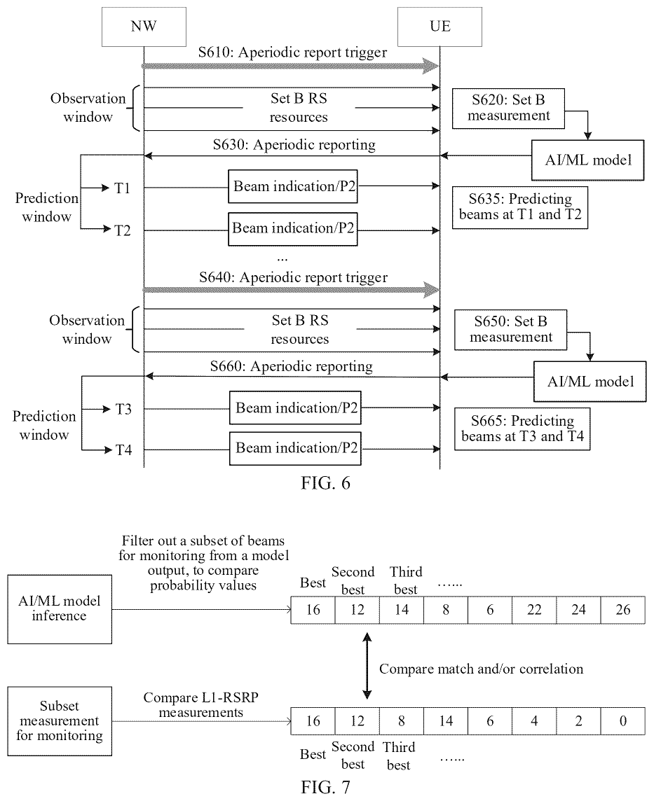

In some embodiments, the observation window of the first device may be aperiodically configured. For example, when the second device may aperiodically send a plurality of beams, the observation window of the first device may be set based on triggering of aperiodic reports. Description is subsequently given below with reference to FIG. 6.

In an example, each time the network needs prediction of a future beam, a trigger instruction may be sent. After beam prediction is triggered, the first device may start an AI/ML model for inference, and predict a future beam based on a measurement result of a current observation window.

In an example, an occasion on which the network triggers beam prediction may be dynamically adjusted based on a network condition, a user location, a channel change, or the like.

In some embodiments, when the observation window is configured aperiodically, the observation window of the first device may be determined based on a trigger instruction. In an example, the length of the observation window in the aperiodic configuration may be defined as duration from “time at which an aperiodic report is triggered” to “time of the report slot”. The length of the observation window may not be fixed, so as to be dynamically adjusted according to an actual situation. For example, the network may set different lengths of observation windows based on a change of a channel condition. In an example, for aperiodic configuration, the length of the observation window may not be configured, but only the length of the prediction window is configured, so as to align a prediction time instance.

The plurality of beams received by the first device are used to determine the first beam set. The first beam set or measured values of the first beam set may be used as an input of the first model. The first beam set may be the set B described above. The first beam set is used to predict the second beam set. The second beam set may be the set A described above.

In some embodiments, the first beam set is some beams in the plurality of beams. In other words, after receiving the plurality of beams in the observation window, the first device selects some beams from the plurality of beams as the first beam set. In this scenario, the first device does not need to determine whether the plurality of beams sent by the second device are used for the set B, the set A, or a non-AI/ML operation. That is, the first device does not need to determine a purpose of a transmit beam, but directly determines the first beam set based on the plurality of beams. In addition, because the first device expects to predict a best beam in the second beam set, after the first device filters the plurality of received beams in advance, the filtering helps reduce a prediction error of predicting the best beam.

In some embodiments, the first beam set is all beams in the plurality of beams. In other words, all the plurality of beams received by the first device in the observation window are used as the first beam set. For example, according to a network configuration, the first device may consider that the received plurality of beams are used for set B. For another example, when a capability of the first device meets a condition, all received beams may be used as the first beam set for inference.

In an example, when the plurality of beams are periodically sent, the first beam set determined from the plurality of beams is also periodically sent. The set B is used as an example. Each terminal device has its prediction window and observation window, and the periodic set B may be easily shared with a plurality of terminal devices. Therefore, when a plurality of terminal devices including the first device use an AI/ML beam management feature, the periodic set B is feasible.

In an example, when the plurality of beams are sent aperiodically, the first beam set determined from the plurality of beams is also sent aperiodically.

The first beam set may be determined based on the first information. In other words, the first device may determine all beams in the first beam set from the plurality of beams based on the first information. For example, the first information may be used by the first device to filter the plurality of received beams, to determine the first beam set. For example, the first information may be used by the first device to determine that the plurality of received beams belong to the first beam set.

The first information includes at least two of: measured values of the plurality of beams, the capability of the first device, or the network configuration. In an example, the first device may select beams good channel quality from among the plurality of beams based on the capability of the first device and RSRP measured values, and use the beams as the first beam set. In an example, the first device may select beams good channel quality from among the plurality of beams based on the network configuration and RSRP measured values as the first beam set. In an example, the first device may determine beams in the first beam set from among the plurality of beams based on the capability of the first device and the network configuration. In an example, the first device may determine the first beam set by comprehensively considering the RSRP measured values, the capability of the first device, and the network configuration.

When the first information includes measured values of a plurality of beams, the first beam set may include N beams with good channel quality in the plurality of beams, where N is a positive integer. Alternatively, the first beam set may include N beams whose channel quality is within a specific range in the plurality of beams.

In some embodiments, measured values of the plurality of beams may be represented by RSRPs, may be represented by signal to interference plus noise ratios (signal to interference plus noise ratio, SINR), or may be represented by other similar parameters.

In some embodiments, measured values of the plurality of beams are measured values measured after the plurality of beams are received, that is, real-time measured values. When receiving the plurality of beams in the observation window, the first device may directly measure the plurality of beams.

In an example, measured values of the plurality of beams may form one measurement vector group, to facilitate processing. For example, an RSRP value of each beam in the first beam set may form a vector, for example, RSRP_{B1}, RSRP^{B2}, . . . , RSRP_{Bn}, where n is a quantity of beams in the first beam set. RSRP measurements of all beams can form a vector group, which is used as an input of the AI/ML model for training or inference. For example, the model may predict best K (Top-K) beams or a most suitable beam (Top-1) in the second beam set based on these measured values.

In some embodiments, measured values of the plurality of beams may include historical measured values of the plurality of beams. The historical measured value may be represented by using a measurement vector, or may be represented in another manner.

In an embodiment, the first device may select the first beam set by analyzing the historical measured values. For example, the first device may determine RSRP measured values of the plurality of beams by weighting historical beam measured values RSRPs with reference to RSRP measurement results of past several time steps, so as to determine the first beam set. For another example, if geographic location information and a motion speed of the first device are known, the network may use the information to further optimize beam selection.

When the first information includes the capability of the first device, the capability of the first device may include information such as a type or algorithm of the first model, a quantity of samples required by the first model, a computing capability of the first device, and a service mode that can be supported by the first device. In some scenarios, capability information of the first device may further include capability information related to beam reception, such as a moving speed and location information of the first device.

In an example, the first device may determine the first beam set based on the capability or the service mode of the first device. For example, the first device may report, to the network, basic information such as a required quantity of samples, a quantity of Tx beams required by the set A and the set B, the type/algorithm of the first model, and a preferred set B mode corresponding to the first model, so that the network configures the first beam set or the first device determines the first beam set from the plurality of beams. For another example, when requesting to collect data for training, the first device may report a model-specific preferred set B mode.

In an example, the first beam set may be one of a plurality of beam sets. The plurality of beam sets may correspond to a plurality of beam set modes related to device capabilities. The plurality of beam set modes are determined based on the network configuration. For example, to reduce RS overheads on the network side, the network may preconfigure a plurality of set B modes, then select an appropriate set B mode, and transmit it to the first device, to generate input data of the AI model. Alternatively, the network may send a plurality of set B modes, and the first device may use a set of the plurality of sets B as an input.

Optionally, when sending the basic information, the first device may not disclose detailed receive (receive, Rx) beam information to the network.

When the first information includes the network configuration, the network may directly configure beams in the first beam set, or may configure a quantity of beams in the first beam set, or may configure different first beam sets for terminal devices in different areas or different types of terminal devices. For example, the network may mark, in framework information of the CSI, which beam IDs may be used as beam IDs in the first beam set. For another example, when the network performs beam sweeping based on terminal devices in several different areas, settings of first beam sets may be different or may be the same. For another example, the network may determine a type of the first device based on the moving speed, the location information, the computing capability, the service mode, and the like of the first device, and configure different first beam sets for different types of terminal devices, so as to facilitate selection by the first device. Detailed configuration information may be reported by the network device and/or obtained through requesting by the first device.

In an embodiment, all beams in the first beam set are N beams with largest measured values in the plurality of beams, where N is determined based on the network configuration. For example, the first device may select N beams with best channel quality (based on RSRPs or other quality parameters) as the first beam set, and then may report the beams to the network device. A value of N may be defined based on a specific network configuration.

In an embodiment, all beams in the first beam set are beams whose measured values are greater than a first threshold in the plurality of beams. The first threshold may be a threshold related to signal quality. For example, the first device may select, based on a specified signal quality threshold RSRPtarget, beams that meet the threshold as the first beam set.

In the foregoing embodiment, the first threshold may be determined based on the network configuration, or may be determined by the first device.

In an embodiment, the first beam set includes a plurality of beam subsets, and the plurality of beam subsets correspond to a plurality of thresholds related to measured values. For example, the first device may select, based on a plurality of specified quality thresholds RSRPtarget, beams that meet different thresholds as beam subsets in the first beam set. The plurality of beam subsets may correspond to one second beam set. The first device may predict the second beam set by using some or all beam subsets in the first beam set.

In the foregoing embodiment, the plurality of thresholds may be determined based on the network configuration, or may be determined by the first device.

In the foregoing embodiment, the plurality of beam subsets may have same or similar quasi co-locations (quasi co-location, QCL).

In the foregoing embodiment, a quantity of beam subsets in the first beam set is determined based on the moving speed and/or a coverage status of the first device. In other words, the first device may determine, based on the speed and the coverage status of the first device, the quantity of beam subsets included in the first beam set to predict the second beam set. For example, a higher speed of the first device indicates that more beam subsets may be used to form the first beam set to predict the second beam set. For another example, for poorer coverage or a location closer to a cell edge, more beam subsets may be used to form the first beam set to predict the second beam set.

In the foregoing embodiment, in a scenario in which the first device is static, location-based beam selection may be more accurate because a channel state change is small. In a high-speed moving scenario, the moving speed of the first device may help predict a trend of fast channel changes, to optimize beam selection. In a multipath propagation environment, the first device may receive signals from a plurality of paths, and different beams may cover different propagation paths. The first device may select a path with good signal quality, and use a corresponding beam as a beam in the first beam set.

It should be understood that, when the location, motion, or environment information of the first device is considered for determining the first beam set, in order to improve a generalization capability of the first model, training data may further include information such as the location, motion speed, and environment of the first device.

S420: Performing, by the first device, beam prediction on the second beam set in the prediction window based on a measured value of the first beam set.

The prediction window may include a plurality of time instances of the first device for beam prediction. In an example, the prediction window is used by the network to perform beam indication or configuration based on a beam prediction result.

In some embodiments, a prediction window of the first device may be periodically configured. For example, when the first beam set is sent periodically, the first device may set one or more prediction windows based on a transmission periodicity of the first beam set, which is subsequently described below with reference to FIG. 5. The first beam set sent periodically may correspond to a plurality of prediction windows, and prediction windows of a plurality of terminal devices may correspond to the plurality of prediction windows respectively.

In an example, each terminal device has a corresponding prediction window. A prediction window used by the first device to perform model inference may differ from, or be the same as, or partially overlap a prediction window used by another terminal device to perform model inference, which is not limited herein.

In an example, for configuration of the length of the prediction window, refer to the configuration or adjustment manner of the length of the observation window. Details are not described herein again.

In a periodic configuration, the prediction window and the observation window of the first device share a same periodicity. The periodicity may be the same as a periodicity of RS resources of a plurality of beams or the first beam set. Therefore, the prediction window may be implicitly determined.

In an embodiment, the length of the prediction window and the length of the observation window are used to determine the first period or the report periodicity for sending a report by the first device. For example, the first period may be a sum of lengths of the prediction window and the observation window. For example, if there is no interval between the observation window and the prediction window, a report periodicity may be completely divided into an observation window and a prediction window. The report periodicity may be the first period. Therefore, duration of the prediction window may be determined by the report periodicity, which is duration of the observation window minus the report periodicity.

In an embodiment, when the prediction window is configured periodically, the prediction window of the first device may be one or more of a plurality of prediction windows. Locations of the plurality of prediction windows may be determined based on a location of an initial prediction window and a first period.

In a periodic configuration, the prediction window and the observation window may not have a same periodicity. For example, the first beam set is configured to have a long periodicity, and the first device needs to perform prediction and reporting in slots between RS resources of two beam sets having a short periodicity. In this case, the NW may further configure a prediction periodicity (prediction periodicity) and a prediction offset (prediction offset) in csi-ReportConfig. The prediction offset means, for example, offsetting the prediction window to a last group of RS resource symbols in the observation window.

In an example, when periodicities of the observation window and the prediction window are different, the prediction window may be determined based on a location of an initial prediction window and a second period. A length of second periodicity is different from that of the first periodicity. Optionally, the length of the second period is less than the length of the first period. Optionally, the length of the second period is greater than the length of the first period.

In an example, the prediction period is a configured prediction window interval, and defines how long the first device performs prediction reporting once.

In an example, the prediction offset is a configured prediction window start slot, and may be determined based on a slot of a last RS resource in the observation window. For example, the start slot of the prediction window is the slot of the last RS resource in the observation window plus an offset of the prediction window.

In some embodiments, the prediction window may be configured based on a configuration of the observation window. For example, prediction windows may be in a one-to-one correspondence with observation windows.

In some embodiments, a prediction window of the first device may be aperiodically configured. For example, when the first beam set is sent aperiodically, the prediction window of the first device may be set based on triggering of aperiodic reports. Description is subsequently given below with reference to FIG. 6.

In an aperiodic configuration, the network may configure the length of the prediction window for the first device, that is, a future period of time to be predicted by the first device. The length of the prediction window may be a fixed length or may be adjusted based on a specific condition (such as a measurement error or AI/ML model performance). In an example, the length of the prediction window may be dynamically adjusted based on a prediction error of the AI/ML model.

For example, the length of the prediction window may include two future time instances that need to be predicted.

For example, assuming that a difference size reaches β (that is, an error between a previous prediction result and an actual measurement result is large), the AI/ML model needs to be fine-tuned, and the length of the prediction window correspondingly needs to be increased, to offset a random error. That is, if the prediction error is large, the network may increase the length of the prediction window, to provide more data for the AI/ML model to correct the error, and improve accuracy of future beam prediction.

A quantity of beams in the second beam set is greater than or equal to a quantity of beams in the first beam set, to predict a larger quantity of beams by using a smaller quantity of beams. It may be learned from the foregoing description that the second beam set may be the set A, and the first beam set may be the set B.

In some embodiments, the first device may perform beam prediction on the second beam set by using the first model. For example, the first device may use measured values of the first beam set as an input of the first model, and then output a best beam in the second beam set by using the first model.

In some embodiments, the first model may perform beam prediction on the second beam set after model training is completed. When the first model is located on the terminal device side, the terminal device or a server connected to the terminal device may collect training data and train the first model. When the first model is located on the network device side, the network device may collect training data and train the first model.

In an example, the training data used to train the first model may be determined based on a purpose of the first model. When the first model is used to predict the second beam set sent by the second device, the training data of the first model may be related to a transmit beam of the second device. For example, the training data is related to a plurality of beams sent by the second device. For another example, the training data is related to the first beam set sent by the second device. For another example, the training data is related to the second beam set sent by the second device.

In some embodiments, the first device may generate the training data. For example, when the first device is a terminal device, the terminal device may generate measured values of a plurality of beams by means of measurement, and use the measured values as training data.

In some embodiments, the first device may collect the training data to perform model training. For example, when the first device includes a terminal device and a first server that trains the first model, both the terminal device and the first server may receive training data sent by another device. A server used by the terminal device to collect the training data may be referred to as a data collection server.

In an example, the first device may generate or collect training data related to a transmit beam of the second device. For example, the terminal device may generate or collect training data, and then send the training data to the first server.

In some embodiments, when the first device is a terminal device, the terminal device may directly use the training data to train the first model. That is, when the first device is a terminal device on which the first model is deployed, an endpoint of the training data may include the terminal device.

In some embodiments, when the first device trains the first model by using the first server, a data collection server of the terminal device may transmit the training data to the first server, so that the first server performs model training.

In the foregoing embodiment, the first server is, for example, an OTT server. When the OTT server is used to train the first model, an endpoint of the training data may include the OTT server.

For ease of understanding, an example in which the first server is an OTT server is used below for exemplary description.

In an example, for a terminal device-side model, the training data may be generated by the terminal device. The endpoint of the training data may include a terminal device or an OTT server on a terminal device side. Operation administration and maintenance (operation administration and maintenance, OAM) or a core network may be used to collect information about training of the terminal device-side model.

In the foregoing example, the OTT server on the terminal device side collects data and trains the model. Therefore, the OTT server on the terminal device side knows what data it needs. Making data collection on the terminal device side be implemented by the OTT server means that the OTT server may more directly collect the data it needs. A required data type does not need to be specified, and when/what to transmit is determined by the terminal device, which can provide sufficient flexibility for a terminal device/chipset vendor to train and implement its specific AI/ML model. The terminal device may use a same method to send training data to OTT server on the terminal device side for model training. Such a process is transparent to the network side and does not require control/visibility from a network/mobile network operator (mobile network operator, MNO).

In an example, the terminal device itself should be responsible for protecting data privacy and obtaining user consent. More specifically, the training data is reported via a user plane (user plane, UP), that is, from an application-level data collection client of the terminal device to an application server (that is, the OTT server on the terminal device side). The terminal device vendor may install a data collection client on the terminal device to collect lower-layer data and report the data to its application server for AI/ML model training. For the data collection application client on the terminal device, data transmission from the terminal device to the application server of the terminal device vendor may be supported in accordance with relevant regulations without participation of the network side. A collected data type/format does not need to be specified, which provides sufficient flexibility for the terminal device to train and implement its specific AI/ML model.

In an example, after collecting the training data, the terminal device may first transmit the training data to a data collection server (within the MNO) for training of the terminal device-side model. Then the training data may be transmitted from this data collection server to an OTT server (outside the MNO). That is, the terminal device may collect data and transmit the data to a server for data collection for training of the terminal device-side model. The data collection server for training on the terminal device-side model can be marked as a first entity.

In the foregoing example, the first entity may choose whether to send the collected data to an OTT server. This OTT server has a different ownership from the OTT server in the previous example. The terminal device may transmit the collected data to the first entity within the MNO through the UP, and then the first entity may choose to forward the collected data to the OTT server. This process depends on implementation by the terminal device.

Still refer to FIG. 4. Step S430: Sending, by the first device, a first report to the second device. The first report is used to determine one or K best beams (that is, top-1 or top-K beams) in the second beam set, where K is a positive integer.

In some embodiments, the first report may be determined based on an output of the first model. When the first model is at a model inference stage, the output of the first model may be an inference result report. The first report may be determined based on the inference result report. For example, the first report may be an inference result report, or a new report may be reported after the inference result report is processed.

In an example, the output of the first model may be a best beam ID in the second beam set, or a probability distribution of beam IDs. In an example, the output of the first model may also be a beam channel quality predicted value or L1-RSRP, and differences between RSRPs of a plurality of beams and an RSRP of a best beam.

In some embodiments, the first report is used to report one of the following information: reporting beam information of the K best beams, where the beam information includes RS indicators or predefined beam indexes of the K best beams; reporting beam information and RSRPs of the K best beams; reporting beam information of the K best beams and predicted probability information of the K best beams in the second beam set; reporting an RSRP difference between a measured RSRP of the first beam set and a best RSRP of a part/all of beams in the second beam set; indicating a strongest beam ID based on a form of a bitmap; reporting predicted RSRPs of a measured beam and a non-measured beam; reporting a predicted RSRP of an unmeasured beam and a measured RSRP of a measured beam; or reporting an error and an error threshold between a predicted RSRP and an actual measured RSRP of each measured beam.

In the foregoing embodiment, the RSRP may be an L1-RSRP, or may include an L1-RSRP.

In the foregoing embodiment, the RSRP may be replaced with an SINR or another parameter indicating signal or channel quality.

In an example, an error threshold between the predicted RSRP and an actual RSRP may be one of a plurality of thresholds configured by a higher layer, or may be a threshold that is determined by the terminal device side by itself and notified to the network side.

In an embodiment, the first report is used to report predicted beam information of top-K beams in a group of beams (second beam set). The beam information of the top-K beams may be an RS indicator (for example, a legacy CRI/SSB RI) or a predefined beam index.

In an embodiment, the first report is used to report predicted beam information of top-K beams in the second beam set and predicted RSRP values of the top-K beams in the second beam set.

In an embodiment, the first report is used to report L1-RSRP differences between measured L1-RSRPs of the first beam set and a best L1-RSRP in a complete set or a subset of the second beam set.

In an embodiment, the first report is used to report predicted beam information of top-K beams in the second beam set and predicted probability information of top-K beams in the second beam set, which is exemplarily described below subsequently with reference to FIG. 7.

In an embodiment, the first report is used to indicate a strongest beam ID based on a form of a bitmap.

In an embodiment, for predicted RSRPs of top-K beams in the inference result report, the first report is used to report predicted L1-RSRPs of a measured beam and a non-measured beam, or to report a predicted RSRP of an unmeasured beam and a measured RSRP of a measured beam. If a beam is not configured for corresponding measurement, a predicted RSRP is reported; if a beam is configured for corresponding measurement, a measured L1-RSRP is reported.

In an embodiment, the first report is used to report L1-RSRP differences between measured L1-RSRPs of predicted beams and a best L1-RSRP in a complete set or a subset of the second beam set.

In an embodiment, the first report is used to report an error between a predicted RSRP and an actual measured RSRP of each measured beam. In this case, the first report may further include a specified error threshold.

In some embodiments, the first report is configured to report at least two of the following: predicted beam information of K best beams; predicted beam information and RSRP values of K best beams; predicted beam information and probability information of K best beams; a difference between a predicted beam RSRP value and a highest RSRP value in some or all beams in the second beam set; or indication of one or K best beams based on a bitmap.

In an embodiment, content of the first report may depend on an option for configuring report content by a base station.

In some embodiments, when the first report is configured to report a plurality of beams, a quantity of beams in the first report may be determined based on a configuration of the base station, or may be determined based on one or more of the following information: nrofReportedRS; nrofTopK: whether the first report is one of a plurality of reports in a current report periodicity; a weight of the first report in a plurality of reports in a current report periodicity; or a prediction error of the beam prediction.

In an embodiment, when nrofReportedRS>1 or nrofReportedRS=M (M is a positive integer) is configured by the network device, a quantity of beams in the first report may be M, or may be less than M.

In an embodiment, when the network configuration received by the first device includes a new beam quantity parameter (for example, nrofTopK), the quantity of beams in the first report is determined by the first device. For example, the first device having an AI/ML capability is allowed to dynamically adjust a quantity of beam reports and a policy through protocol extension or parameter adjustment (for example, introduction of a new parameter nrofTopK)). In this manner, the network may receive a report of best top-K beams of the first device without requiring all first devices to report a same quantity of beams.

In a sub-embodiment of the foregoing embodiment, the network device (for example, a gNB) may convey parameter information nrofTopK to the first device by using a radio resource control (radio resource control, RRC) connection configuration message, to allow the first device to dynamically adjust a quantity of beams for reporting. When the network shares this new parameter with the first device, it means that under some conditions (for example, a location of the first device remains unchanged and an additional network condition remains unchanged), the first device may report a quantity of beams less than nrofReportedRS.

In an embodiment, the quantity of reports in the first report may be determined based on a prediction error of beam prediction. For example, the first device may evaluate reliability of the AI/ML model inference result by calculating an error between a predicted L1-RSRP value of each beam and an actually measured L1-RSRP value. If the prediction error is very low, the prediction result of the model is highly reliable. In this scenario, the first device may report top-K beams based on predicted L1-RSRP values, where K may be less than a configured value of nrofReportedRS.

In a sub-embodiment of the foregoing embodiment, the first device may set an error threshold. If some beams have prediction errors below this threshold, these beams may be considered as “high confidence beams” and a smaller quantity of top-K beams may be selected to report. If an error is higher than the threshold, the first device needs to further adjust a beam reporting policy to ensure coverage of all possibly important M beams.

In an embodiment, when the quantity of beams in the first report is less than the value of nrofReportedRS, the first device may send the first report by using a multi-round reporting policy. That is, if a quantity of beams determined by the first device in one beam report is less than the value of nrofReportedRS configured by the network, a multi-round reporting policy may be used. For example, the first report is one of a plurality of reports, and a quantity of the plurality of reports is determined based on the value of nrofReportedRS and a quantity of beams in each report. For another example, the first report includes a plurality of reports that are reported in a plurality of rounds.

In a sub-embodiment of the foregoing embodiment, the first device may first report beams (top-K beams) with a small prediction error in 1^{st} report. If the network has a further requirement on the quantity of beams, the first device may gradually supplement other beams in subsequent reporting.

In a sub-embodiment of the foregoing embodiment, a plurality of reports reported in a plurality of rounds may correspond to a plurality of transmission priorities. When the first report is one of a plurality of reports, a transmission priority of the first report may be determined based on a beam prediction error in the first report.

In a sub-embodiment of the foregoing embodiment, the first device may assign a weight to each of the plurality of reports to determine the transmission priority. The weight may be determined based on a value of an L1-RSRP prediction error. For example, for a beam with a small prediction error, a weight is high, and a reporting priority is high. For a beam with a large error, a weight is low, and reporting may be delayed or not performed.

For example, when the first report is one of a plurality of reports, the weight of the first report may be a first weight. The first weight may be used to determine a transmission priority of the first report, and the first weight is determined based on a beam prediction error in the first report.

The method for determining the first beam set and the content of the first report by the first device is described above with reference to FIG. 4. In the method shown in FIG. 4, sending of the first beam set may be periodic or aperiodic. Accordingly, the first report may be sent periodically or aperiodically. The following describes periodic reporting and aperiodic reporting as examples with reference to FIG. 5 and FIG. 6. Both FIG. 5 and FIG. 6 are described from a perspective of interaction between UE (a first device) and an NW (a second device), and the first model is located on a UE side.

In a periodic report process, the NW may configure periodic reporting and an offset, which are used to define a quantity of slots (slots) at which the first device reports once and a slot from which reporting starts. From the configured periodic reporting and offset, the first device may further identify a reporting slot for each report instance. For example, a parameter ReportPeriodityAndOffset may be used to configure the network to trigger periodic prediction reporting in slot 0. For another example, a parameter ResourcePeriodityAndOffset may be used to configure a periodicity of RS resources and an offset.

Optionally, through combination of values of ReportPeriodityAndOffset and ResourcePeriodityAndOffset, the first device may determine a time point of each measurement and report, and accordingly calculate a length of the observation window.

Optionally, when RS resources of the first beam set are configured as periodic RS resources, a prediction time instance (prediction window) related to sending of periodic reporting may be further configured.

FIG. 5 shows an entire process of periodic reporting, where the process may implement periodic model inference for beam management. In this process, UE may continuously measure L1-RSRPs of RS resources of a periodic set: first beam set.

Refer to FIG. 5. Step S510: Sending, by an NW, a periodic report trigger to the UE in slot 0.

Step S520, Sending, by the NW, a plurality of beams in a 1^{st} observation window (RS resources in a set B (first beam set)); and measuring, by the UE, the first beam set, and inputting the first beam set into an AI/ML model.

Step S530: Sending, by the UE, a 1^{st} periodic report based on an output of the AI/ML model. The 1^{st} periodic report may be used by the NW to design beam indications P2 at moments T1 and T2. The two beam indications P2 may correspond to beam predictions performed by the UE at moments T1 and T2 in step S535.

Step S540: Sending, by the NW, a plurality of beams in a 2^{nd} observation window (RS resources in the set B (first beam set)); and measuring, by the UE, the first beam set, and inputting the first beam set into an AI/ML model.

Step S550: Sending, by the UE, a 2^{nd} periodic report based on an output of the AI/ML model. The 2^{nd} periodic report may be used by the NW to design beam indications P2 at moments T3 and T4. The two beam indications P2 may correspond to beam predictions performed by the UE at moments T3 and T4 in step S555.

In FIG. 5, a start slot of the RS resources may be slot n, and slot n is determined based on a resource offset amount. The first beam set may be sent in an observation window. The UE may predict best beams in one or more future slots by using measured values of the first beam set as a model input, and report prediction information of best beams in the second beam set at moments T1, T2, T3, and T4 to the NW. T1 and T2 are time instances in a 1^{st} prediction window, and T3 and T4 are time instances of a 2^{nd} prediction window. Based on each future slot, the NW may perform beam indication and/or configure a P2/P3 procedure according to model output design. An interval between two periodic reports may be determined based on a report periodicity.

FIG. 6 shows an entire process of aperiodic reporting, where the process may implement aperiodic model inference for beam management.

Refer to FIG. 6. Step S610: Sending, by an NW, an aperiodic report trigger to the UE.

Step S620 is the same as step S520 in FIG. 5, and details are not described again.

Step S630: Sending, by the UE, an aperiodic report to the NW. The aperiodic report may be used by the NW to design beam indications P2 at moments T1 and T2. The two beam indications P2 may correspond to beam predictions performed by the UE at moments T1 and T2 in step S635.

Step S640: Sending, by the NW, an aperiodic report trigger to the UE again.

Step S650 is the same as step S540 in FIG. 5, and details are not described again.

Step S660: Sending, by the UE, an aperiodic report to the NW. The aperiodic report may be used by the NW to design beam indications P2 at moments T3 and T4. The two beam indications P2 may correspond to beam predictions performed by the UE at moments T3 and T4 in step S665.

In FIG. 6, the NW may configure, only in the observation window, RS resources for transmitting the first beam set. The RS resources are configured as a combination of a plurality of aperiodic resources and connected by aperiodic reporting. Therefore, the NW does not need to configure a length of the observation window in csi-ReportConfig. However, for a length of the prediction window, the NW and the UE need to align to determine duration of a prediction window and where a predicted future slot is. Therefore, a periodicity and the length of the prediction window needs to be configured in a CSI framework.

The foregoing describes that the first report may include predicted probability information of top-K beams. The following describes probability information in the first report with reference to FIG. 7. The probability information may be a probability that a beam becomes a Top-1 beam or one of top-K beams. Based on the probability information, model performance may be understood to some extent. For example, the probability information may be used to sort candidate beams and similarity of a sorted sequence may be compared with RSRP-sorted sequence of beams. Although different models may output different levels of probability information, if the probability information of the beams is accurate enough, final rankings of the beams should be the same or similar.

FIG. 7 is an example of comparison between beam rankings from model inference and beam rankings from monitoring and measurement on a subset of the second beam set. As shown in FIG. 7, for comparison purposes, the subset of beams from a model output that are configured for measurement may be filtered out, to compare probability scores (compare probability score by filtering this subset of beams from model output), as shown in FIG. 7. A measurement result may be an L1-RSRP value.

Refer to FIG. 7. Two examples of best eight beams are derived from model inference and monitoring measurements by comparing probability scores and measured L1-RSRP, respectively. Beams in FIG. 7 are beams whose beam IDs are even numbers. It may be learned from FIG. 7 that eight best beams inferred by the model differ from eight best beams obtained by measurement to some extent. For example, the best (best) beam ID from model inference is 16, the second best (2^{nd} best) beam ID is 12, the third best (3^{rd} best) beam ID is 14, and the 4^{th} best beam ID is 8; the best beam ID from actual measurement is 16, the second best (2^{nd} best) beam ID is 12, the 3^{rd} best (3^{rd} best) beam ID is 8, and the 4^{th} beam ID is 14.

In FIG. 7, whether rankings from model inference match rankings from actual measurement are compared and/or their correlation is calculated (compare if match and/or correlation), to determine model performance. The correlation may be Spearman correlation (spearman correlation) or Kendall correlation (Kendall correlation), thereby evaluating beam prediction ranking accuracy between model inference and actual measurement. A higher correlation coefficient indicates better consistency between model prediction and actual measurement, reflecting better prediction performance of the model.

The foregoing describes the method embodiments of the present application in detail with reference to FIG. 1 to FIG. 7. The following describes in detail the apparatus embodiments of the present application with reference to FIG. 8 to FIG. 10. It should be understood that the description of the apparatus embodiments corresponds to the description of the method embodiments. Therefore, for parts that are not described in detail, one may refer to the foregoing method embodiments.

FIG. 8 is a schematic block diagram of a wireless communication apparatus according to an embodiment of the present application. The apparatus 800 may be any one of the first devices described above. The first device may be a terminal device. The apparatus 800 shown in FIG. 8 includes a transceiver unit 810 and a processing unit 820.

The transceiver unit 810 may be configured to receive, in an observation window, a plurality of beams sent by a second device, where the plurality of beams are used to determine a first beam set. The processing unit 820 is configured to perform beam prediction on a second beam set in the prediction window based on a measured value of the first beam set. The transceiver unit 810 is further configured to send a first report to the second device. The first report is used to determine one or K best beams in the second beam set, K is a positive integer, and the first beam set is determined based on first information. The first information includes at least two of: measured values of the plurality of beams, a capability of the first device, or a network configuration.

Optionally, the first report is used to report one of the following information: reporting beam information of the K best beams, where the beam information includes reference signal indicators or predefined beam indexes of the K best beams; reporting beam information and RSRPs of the K best beams; reporting beam information of the K best beams and predicted probability information of the K best beams in the second beam set; reporting an RSRP difference between a measured RSRP of the first beam set and a best RSRP of a part/all of beams in the second beam set; indicating a strongest beam ID based on a form of a bitmap; reporting predicted RSRPs of a measured beam and a non-measured beam; reporting a predicted RSRP of an unmeasured beam and a measured RSRP of a measured beam; or reporting an error and an error threshold between a predicted RSRP and an actual measured RSRP of each measured beam.

Optionally, all beams in the first beam set are one of the following: N beams with largest measured values in the plurality of beams, where N is a positive integer, and N is determined based on a network configuration; or beams whose measured values are greater than a first threshold in the plurality of beams, where the first threshold is determined based on a network configuration.

Optionally, the first beam set includes a plurality of beam subsets, and the plurality of beam subsets correspond to a plurality of thresholds related to measured values; and a quantity of beam subsets in the first beam set is determined based on a moving speed and/or a coverage status of the first device.

Optionally, the first beam set is one of a plurality of beam sets, the plurality of beam sets correspond to a plurality of beam set modes related to capabilities, and the plurality of beam set modes are determined based on a network configuration.

Optionally, the measured values of the plurality of beams include historical measured values of the plurality of beams, and the historical measured values are represented by measurement vectors.

Optionally, the observation window is one of a plurality of observation windows, and locations of the plurality of observation windows are determined based on a location of an initial observation window and a first periodicity; and the first beam set is used for repeated transmission in the plurality of observation windows.

Optionally, the first device is one of a plurality of devices, and the plurality of devices perform beam prediction based on a first beam set in any observation window of the plurality of observation windows.

Optionally, a length of the observation window is configured or adjusted based on one or more of the following manners: performing configuration by using a third parameter, where the third parameter is used to define the length of the observation window; determining the length of the observation window by using a report offset and a resource offset; increasing the length of the observation window by increasing a report periodicity or decreasing a reference signal resource offset; reducing the length of the observation window by reducing a report periodicity or increasing a reference signal resource offset; or predicting the length of the observation window based on the quantity of time instances corresponding to the first beam set.

Optionally, the prediction window is one of a plurality of prediction windows, and locations of the plurality of prediction windows are determined based on a location of an initial prediction window and the first periodicity; and a length of the prediction window and the length of the observation window are used to be determined as the report periodicity.

Optionally, the prediction window is one of a plurality of prediction windows, the prediction window is determined based on a location of an initial prediction window and a second period, and a length of the second period is less than a length of the first period.

Optionally, a location of the observation window is determined based on a trigger instruction.

Optionally, a quantity of beams in the first report is determined based on one or more of the following information: nrofReportedRS; nrofTopK: whether the first report is one of a plurality of reports in a current report periodicity; a weight of the first report in a plurality of reports in a current report periodicity; or a prediction error of the beam prediction.

Optionally, when the quantity of beams in the first report is less than a value of nrofReportedRS, the first report is one of the plurality of reports, and the quantity of the plurality of reports is determined based on the value of nrofReportedRS and a quantity of beams in each report.

Optionally, the plurality of reports correspond to a plurality of transmission priorities, a first weight of the first report is used to determine a transmission priority of the first report, and the first weight is determined based on a beam prediction error in the first report.

Optionally, when a network configuration received by the first device includes nrofTopK, the quantity of beams in the first report is determined by the first device.

Optionally, the beam prediction is implemented by using a first model, and the first model is an artificial intelligence or machine learning model.

Optionally, the first model is located on a terminal device side, the first device includes a terminal device and a first server that trains the first model, and the processing unit 820 is further configured to generate or collect training data related to a transmit beam of the second device; and the terminal device is configured to send the training data to the first server.

FIG. 9 is a schematic block diagram of another wireless communication apparatus according to an embodiment of the present application. The apparatus 900 may be any one of the second devices described above. The second device may be a terminal device or a network device. The second device 900 shown in FIG. 9 includes a transceiver unit 910.

The transceiver unit 910 may be configured to send a plurality of beams in an observation window, where the plurality of beams are used to determine a first beam set. The transceiver unit 910 is further configured to receive a first report sent by a first device. The first report is used to determine one or K best beams in a second beam set in a prediction window, K is a positive integer, beam prediction of the second beam set is performed based on a measured value of the first beam set, and the first beam set is determined based on first information. The first information includes at least two of: measured values of the plurality of beams, a capability of the first device, or a network configuration.

Optionally, the first report is used to report one of the following information: reporting beam information of the K best beams, where the beam information includes reference signal indicators or predefined beam indexes of the K best beams; reporting beam information and RSRPs of the K best beams; reporting beam information of the K best beams and predicted probability information of the K best beams in the second beam set; reporting an RSRP difference between a measured RSRP of the first beam set and a best RSRP of a part/all of beams in the second beam set; indicating a strongest beam ID based on a form of a bitmap; reporting predicted RSRPs of a measured beam and a non-measured beam; reporting a predicted RSRP of an unmeasured beam and a measured RSRP of a measured beam; or reporting an error and an error threshold between a predicted RSRP and an actual measured RSRP of each measured beam.

Optionally, all beams in the first beam set are one of the following: N beams with largest measured values in the plurality of beams, where N is a positive integer, and N is determined based on a network configuration; or beams whose measured values are greater than a first threshold in the plurality of beams, where the first threshold is determined based on a network configuration.

Optionally, the first beam set includes a plurality of beam subsets, and the plurality of beam subsets correspond to a plurality of thresholds related to measured values; and a quantity of beam subsets in the first beam set is determined based on a moving speed and/or a coverage status of the first device.

Optionally, the first beam set is one of a plurality of beam sets, the plurality of beam sets correspond to a plurality of beam set modes related to capabilities, and the plurality of beam set modes are determined based on a network configuration.

Optionally, the measured values of the plurality of beams include historical measured values of the plurality of beams, and the historical measured values are represented by measurement vectors.

Optionally, the observation window is one of a plurality of observation windows, and locations of the plurality of observation windows are determined based on a location of an initial observation window and a first periodicity; and the first beam set is used for repeated transmission in the plurality of observation windows.

Optionally, the first device is one of a plurality of devices, and the plurality of devices perform beam prediction based on a first beam set in any observation window of the plurality of observation windows.

Optionally, a length of the observation window is configured or adjusted based on one or more of the following manners: performing configuration by using a third parameter, where the third parameter is used to define the length of the observation window; determining the length of the observation window by using a report offset and a resource offset; increasing the length of the observation window by increasing a report periodicity or decreasing a reference signal resource offset; reducing the length of the observation window by reducing a report periodicity or increasing a reference signal resource offset; or predicting the length of the observation window based on the quantity of time instances corresponding to the first beam set.

Optionally, the prediction window is one of a plurality of prediction windows, and locations of the plurality of prediction windows are determined based on a location of an initial prediction window and the first periodicity; and a length of the prediction window and the length of the observation window are used to be determined as the report periodicity.

Optionally, the prediction window is one of a plurality of prediction windows, the prediction window is determined based on a location of an initial prediction window and a second period, and a length of the second period is less than a length of the first period.

Optionally, a location of the observation window is determined based on a trigger instruction.

Optionally, a quantity of beams in the first report is determined based on one or more of the following information: nrofReportedRS; nrofTopK: whether the first report is one of a plurality of reports in a current report periodicity; a weight of the first report in a plurality of reports in a current report periodicity; or a prediction error of the beam prediction.

Optionally, when the quantity of beams in the first report is less than a value of nrofReportedRS, the first report is one of the plurality of reports, and the quantity of the plurality of reports is determined based on the value of nrofReportedRS and a quantity of beams in each report.

Optionally, the plurality of reports correspond to a plurality of transmission priorities, a first weight of the first report is used to determine a transmission priority of the first report, and the first weight is determined based on a beam prediction error in the first report.

Optionally, when a network configuration received by the first device includes nrofTopK, the quantity of beams in the first report is determined by the first device.

Optionally, the beam prediction is implemented by using a first model, and the first model is an artificial intelligence or machine learning model.

Optionally, the first model is located on a terminal device side, the first device includes a terminal device and a first server that trains the first model, and training data related to a transmit beam of the second device is sent by the terminal device to the first server.

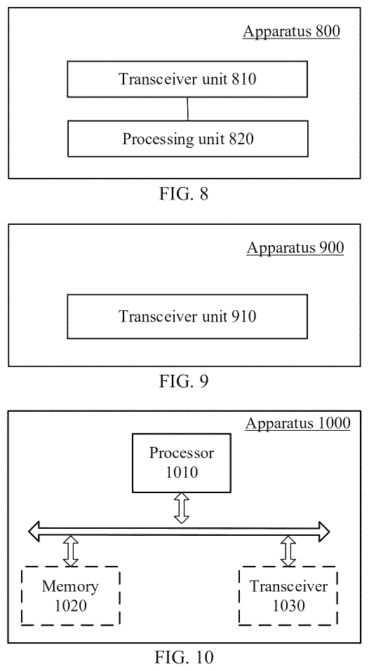

FIG. 10 is a schematic structural diagram of a communication apparatus according to an embodiment of the present application. Dashed lines in FIG. 10 indicate that a unit or module is optional. The apparatus 1000 may be configured to implement the methods described in the foregoing method embodiments. The apparatus 1000 may be a chip, a terminal device, or a network device.

The apparatus 1000 may include one or more processors 1010. The processor 1010 may support the apparatus 1000 in implementing the methods described in the foregoing method embodiments. The processor 1010 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program, and the program may be executed by the processor 1010, to cause the processor 1010 to execute the method described in the foregoing method embodiment. The memory 1020 may be separate from the processor 1010 or may be integrated into the processor 1010.

The apparatus 1000 may further include a transceiver 1030. The processor 1010 may communicate with another device or chip by using the transceiver 1030. For example, the processor 1010 may transmit data to and receive data from another device or chip by using the transceiver 1030.

An embodiment of the present application further provides a computer-readable storage medium for storing a program. The computer-readable storage medium may be applied to the terminal device or the network device provided in embodiments of the present application, and the program causes a computer to execute the method executed by the terminal device or the network device in various embodiments of the present application.

The computer-readable storage medium may be any available medium accessible by a computer or a data storage device such as a server or a data center that integrates one or more available media. The usable medium may be a magnetic medium (for example, a floppy disk, a hard disk, or a magnetic tape), an optical medium (for example, a digital video disc (digital video disc, DVD), a semiconductor medium (for example, a solid state disk (solid state disk, SSD)), or the like.

An embodiment of the present application further provides a computer program product. The computer program product includes a program. The computer program product may be applied to the terminal device or the network device provided in embodiments of the present application, and the program causes a computer to execute the methods executed by the terminal device or the network device in various embodiments of the present application.

All or some of the foregoing embodiments may be implemented by using software, hardware, firmware, or any combination thereof. When the software is used for implementation, all or some of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, through a coaxial cable, an optical fiber, or a digital subscriber line (digital subscriber line, DSL)) manner or a wireless (for example, infrared, wireless, and microwave) manner.

An embodiment of the present application further provides a computer program. The computer program may be applied to the terminal device or the network device provided in embodiments of the present application, and the computer program causes a computer to execute the methods executed by the terminal device or the network device in various embodiments of the present application.

The terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular order. In addition, the terms “include” and “have”and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between two elements, or that there is an association between two elements, or that there is a relationship of “indicating” and “being indicated”, “configuring”and “being configured”, or the like.

In embodiments of the present application, “pre-defining” or “pre-configuring” can be implemented by pre-storing corresponding codes, tables, or other forms that may be used to indicate related information in devices (for example, including a terminal device and a network device). A specific implementation thereof is not limited in the present application. For example, being pre-defined may refer to being defined in a protocol.

In embodiments of the present application, the “protocol” may indicate a standard protocol in the communication field, which may include, for example, an LTE protocol, an NR protocol, and a related protocol applied to a future communication system. This is not limited in the present application.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or”relationship between the associated objects.

In embodiments of the present application, sequence numbers of the foregoing processes do not mean execution orders. The execution orders of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. Indirect couplings or communication connections between apparatuses or units may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a first device in an observation window, a plurality of beams from a second device, wherein the plurality of beams are used to determine a first beam set;
performing, by the first device, beam prediction on a second beam set in a prediction window based on measured values of the first beam set; and
sending, by the first device, a first report to the second device,
wherein the first report comprises information for one or K best beams in the second beam set, K is a positive integer, and the first beam set is determined based on first information; and the first information comprises at least two of: measured values of the plurality of beams, a capability of the first device, or a network configuration.

2. The method according to claim 1, wherein the first report comprises one of the following information:
beam information of the K best beams, wherein the beam information comprises reference signal indicators or predefined beam indexes of the K best beams;
beam information and reference signal received power (RSRPs) of the K best beams;
beam information of the K best beams and predicted probability information of the K best beams in the second beam set;
an RSRP difference between a measured RSRP of the first beam set and a best RSRP of at least part of beams in the second beam set;
a strongest beam identity (ID) based on a form of a bitmap;
predicted RSRPs of a measured beam and a non-measured beam;
a predicted RSRP of an unmeasured beam and a measured RSRP of a measured beam; or
an error and an error threshold between a predicted RSRP and an actual measured RSRP of each measured beam.

3. The method according to claim 1, wherein all beams in the first beam set are one of the following:
N beams with largest measured values in the plurality of beams, wherein N is a positive integer, and N is determined based on a network configuration; or
beams whose measured values are greater than a first threshold in the plurality of beams, wherein the first threshold is determined based on a network configuration.

4. The method according to claim 1, wherein the first beam set comprises a plurality of beam subsets, and the plurality of beam subsets correspond to a plurality of thresholds related to measured values; and a quantity of beam subsets in the first beam set is determined based on at least one of a moving speed or a coverage status of the first device.

5. The method according to claim 1, wherein the first beam set is one of a plurality of beam sets, the plurality of beam sets correspond to a plurality of beam set modes related to capabilities, and the plurality of beam set modes are determined based on a network configuration.

6. The method according to claim 1, wherein the measured values of the plurality of beams comprise historical measured values of the plurality of beams, and the historical measured values are represented by measurement vectors.

7. The method according to claim 1, wherein the observation window is one of a plurality of observation windows, and locations of the plurality of observation windows are determined based on a location of an initial observation window and a first periodicity; and the first beam set is used for repeated transmission in the plurality of observation windows.

8. The method according to claim 7, wherein the first device is one of a plurality of devices, and the plurality of devices perform beam prediction based on a first beam set in any observation window of the plurality of observation windows.

9. The method according to claim 7, wherein a length of the observation window is configured or adjusted based on one or more of the following manners:
performing configuration by using a third parameter, wherein the third parameter is used to define the length of the observation window;
determining the length of the observation window by using a report offset and a resource offset;
increasing the length of the observation window by increasing a report periodicity or decreasing a reference signal resource offset;
reducing the length of the observation window by reducing a report periodicity or increasing a reference signal resource offset; or
predicting the length of the observation window based on a quantity of time instances corresponding to the first beam set.

10. The method according to claim 7, wherein the prediction window is one of a plurality of prediction windows, and locations of the plurality of prediction windows are determined based on a location of an initial prediction window and the first periodicity; and a length of the prediction window and the length of the observation window are used to be determined as a report periodicity.

11. The method according to claim 7, wherein the prediction window is one of a plurality of prediction windows, the prediction window is determined based on a location of an initial prediction window and a second period, and a length of the second period is less than a length of the first periodicity.

12. The method according to claim 1, wherein a location of the observation window is determined based on a trigger instruction.

13. The method according to claim 1, wherein a quantity of beams in the first report is determined based on one or more of the following information:
nrofReportedRS;
nrofTopK:
whether the first report is one of a plurality of reports in a current report periodicity;
a weight of the first report in a plurality of reports in a current report periodicity; or
a prediction error of the beam prediction.

14. The method according to claim 13, wherein when the quantity of beams in the first report is less than a value of nrofReportedRS, the first report is one of the plurality of reports, and the quantity of the plurality of reports is determined based on the value of nrofReportedRS and a quantity of beams in each report.

15. The method according to claim 14, wherein the plurality of reports correspond to a plurality of transmission priorities, a first weight of the first report is used to determine a transmission priority of the first report, and the first weight is determined based on a beam prediction error in the first report.

16. The method according to claim 13, wherein when a network configuration received by the first device comprises nrofTopK, the quantity of beams in the first report is determined by the first device.

17. The method according to claim 1, wherein the beam prediction is implemented by using a first model, and the first model is an artificial intelligence or machine learning model.

18. The method according to claim 17, wherein the first model is located on a terminal device side, the first device comprises a terminal device and a first server that trains the first model, and the method further comprises:
generating or collecting, by the first device, training data related to a transmit beam of the second device; and
sending, by the terminal device, the training data to the first server.

19. A wireless communication method, comprising:
sending, by a second device, a plurality of beams in an observation window, wherein the plurality of beams are used to determine a first beam set; and
receiving, by the second device, a first report from a first device,
wherein the first report comprises information for one or K best beams in a second beam set in a prediction window, K is a positive integer, beam prediction of the second beam set is performed based on a measured value of the first beam set, and the first beam set is determined based on first information; and the first information comprises at least two of: measured values of the plurality of beams, a capability of the first device, or a network configuration.

20. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving, in an observation window, a plurality of beams from a second device, wherein the plurality of beams are used to determine a first beam set;
performing beam prediction on a second beam set in a prediction window based on measured values of the first beam set; and
sending a first report to the second device,
wherein the first report comprises information for one or K best beams in the second beam set, K is a positive integer, and the first beam set is determined based on first information; and
the first information comprises at least two of: measured values of the plurality of beams, a capability of the apparatus, or a network configuration.
